(19) United States
(12) Patent Application Publication
(10) Pub. No.: US 2009/0274533 A1
(43) Pub. Date: Nov. 5, 2009

(54) Cover plate anchor with cover plate engagement structure

(76) Inventors: Gunther Zimmer, Rheinau (DE); Martin Zimmer, Rheinau (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 12/386,572

(22) Filed: Apr. 20, 2009

Related U.S. Application Data
(63) Continuation-in-part of application No. PCT/DE2007/001866, filed on Oct. 19, 2007.

(30) Foreign Application Priority Data
Oct. 19, 2006 (DE) 10 2006 049 952.2

(51) Int. Cl. F16B 13/06; F16B 13/04

(52) U.S. Cl. 411/49; 411/57.1; 411/80

(57) ABSTRACT

In an anchor for the attachment to flat building components including two cover plates and an intermediate support core layer wherein the anchor comprises an expansion body and a wedge body which is inserted into the expansion body and includes an opening for inserting a mounting means, the installed anchor is disposed in an opening of the building component which extends through one cover plate and the intermediate support core plate and into a dead end bore of the other cover plate. The expansion body has spreadable engagement elements, wherein, with the anchor installed, one cylinder zone is in contact with the bore wall of the first cover plate, and a wedging zone spreads out the expansion body in the intermediate support core and in the dead end bore of the second cover plate.

This is a continuation-in-part application of pending international patent application PCT/DE2007/001866 filed Oct. 19, 2007 and claiming the priority of German patent application 10 2006 049 952.2 filed Oct. 19, 2006.

### BACKGROUND OF THE INVENTION

The invention resides in an anchor for mounting in a planar building component having first and second cover plates with an intermediate support core layer, wherein the anchor includes at least an expansion body and at least one wedge body and wherein the wedge body, which is at least partially inserted into the spreading body, includes a cavity for threading or punching a mounting member into the anchor.

Flat construction components are often designated as sandwich plates, honeycomb plates or light weight construction plates. All plate types used in furniture construction comprise generally cover layers of thin particle boards, medium or high density fiber boards, plywood or hard fiber boards. The sandwich plates often have an intermediate support structure comprising corrugated web inserts or so-called expanded honeycombs. Most lightweight construction plates have a raw density below 500 kg/m³. If as intermediate layers no fire resistant foamed aluminum or foamed glass is used, the raw density is below 350 kg/m³. For comparison, the raw density of a normal particle board is about 600 to 750 kg/m³.

If fixtures are to be attached to light-weight plates for example, by screws, the problem arises that the attachment means find support only in the relatively thin cover layers or cover plates. Typical solutions in such cases are spreading anchors as they are disclosed in the printed publication DE 20 204 000 474 V1. The spreading anchors however have the disadvantage that they engage the upper plate in the front and the back side over a large area. The rear engagement additionally displaces the support core material over a large area around the bore, whereby the cover plate is more easily detached from the support core material and is lifted off if the anchor is subjected to high tension forces.

Another anchor which avoids this disadvantage is known from the internet catalog (September 2006) of the comparing Fischer Befestigungssysteme GmbH. It is listed there under the designation SLM-N. The anchor has a tubular spreading body, into whose bore an at least sectionally truncated cone-shaped wedge body is inserted at the rear slotted spreading body end. The wedge body has a central bore with an internal thread. If the wedge body is moved into the spreading body for example by tightening of a retaining screw which is disposed in the thread of the wedge body, the spreading body is spread and clamped, that is, engaged in the lower area of the bore. However, this anchor would require a very rigid core material to be firmly engaged therein.

The object of the present invention is to provide an anchor for lightweight construction panels which is easy to install and which is safely and durably engaged in the lightweight construction panel.

### SUMMARY OF THE INVENTION

In an anchor for the attachment to flat building components including two cover plates and an intermediate support core layer wherein the anchor comprises an expansion body and a wedge body which is inserted into the expansion body and includes an opening for installing a mounting means, the installed anchor is disposed in an opening of the building component which extends through one of the cover plates and the intermediate support core plate and into a dead end bore of the second cover plate. The expansion body has spreadable engagement elements, wherein, with the anchor installed, one cylinder zone is in contact with the bore wall of the first cover plate, and a wedging zone spreads out the expansion body in the intermediate support core and in the dead end bore of the second cover plate.

To this end, the installed anchor is disposed in an opening of the building component which extends through the first cover plate and the intermediate support core layer and as dead end bore partially into the second cover plate. The expansion body has at least two spreadable engagement elements, a locking zone and a support zone. The wedge body comprises at least one cylinder zone, at least one wedging zone and at least one locking zone. With the anchor installed, one cylinder zone is in contact with the bore wall of the first cover plate, a wedging zone spreads the engagement elements of the expansion body behind the first cover plate so that they abut the first cover plate and the locking zones are interlocked and the support zone of the expansion body is disposed in the dead end bore of the second cover plate axially and radially in firm contact therewith by expansion by means of the clamping zone (95) of the wedge body (60).

Preferably, a cement material cartridge is arranged between the expansion body and the wedge body. The cement material cartridge raptures upon insertion of the wedge body into the expansion body so that the cement material flows into the mounting area between the expansion body and the lower cover plate.

There may be no interlocking between the spreading body and the wedge body.

With the present invention, an anchor for lightweight building plates is provided which has a high retaining force and can be rapidly installed manually as well as by a machine.

The invention will become more readily apparent from the following description of schematically shown embodiments.

### BRIEF DESCRIPTION OF THE DRAWINGS

It is shown in:

FIG. 1: A perspective representation of an expanded anchor;

FIG. 2: An unspread expansion body of the anchor of FIG. 1;

FIG. 3: The wedging body of FIG. 1;

FIG. 4: An expansion body inserted into a light-weight building panel;

FIG. 5: An anchor mounted with the expansion body of FIG. 4;

FIG. 6: The expansion body with a cement material balloon;

FIG. 7: The installed anchor with the expansion body according to FIG. 6;

FIG. 8: Same as FIG. 1, but being provided with different longitudinal slots and the wedging body partially inserted,

FIG. 9: An enlargement of a detail of FIG. 5;

FIG. 10: A representation of the lightweight construction panel bore;

FIG. 11: The anchor with a different screw-in arrangement;

FIG. 12: The anchor without locking structure;

FIG. 13: A cross-section of an anchor with eccentric expansion in non-deformed state;

FIG. 14: Cross-section of an anchor with eccentric expansion in a deformed state.

### DESCRIPTION OF PARTICULAR EMBODIMENT

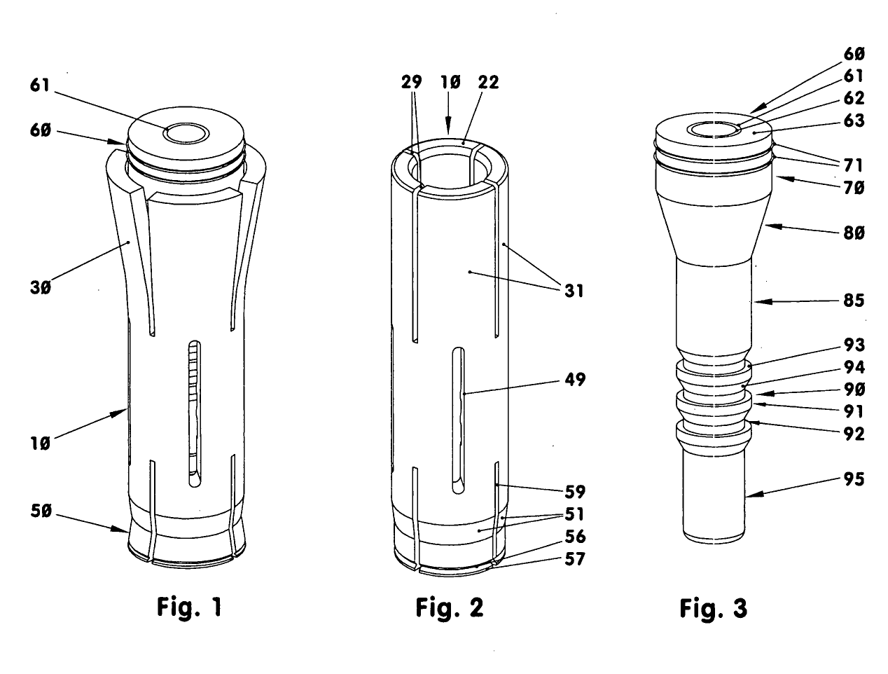

FIG. 1 shows a spread anchor in the form which it would have after installation in a lightweight construction panel. In this embodiment, the anchor has only two parts, an expansion body (10) and a wedge body (60). Both parts (10, 60) are shown separately in FIGS. 2 and 3. The anchor according to FIG. 1 has for example a length of 35 mm. The opening drilled for mounting the anchor has for example a diameter of 8.5 mm. The diameter of the unexpanded anchor is in this design either maximally three times the core diameter of the screw to be installed via the anchor in the lightweight building plate or, maximally 2.3 times the actual diameter of the screw when threaded into the anchor.

The anchor is provided for example for the mounting of fixtures to light-weight construction panels (100) without walers and solid inserts, see FIG. 10. The shown lightweight building panel (100) comprises two cover plates (101) and 111) and an intermediate support core (121). Each cover plate (101, 111) consists in the shown embodiment of a thin particle board. The support core (121) is for example a PU foam core. The cover plates (101, 111) are glued with their inner surfaces (103, 113) to the plate-shaped support core (121). The lightweight building panel as shown has a wall thickness of 37.5 mm. Each cover plate is in this case four millimeters thick. Instead of a foam core, a honeycomb core structure may be provided. The lightweight construction panel includes a bore (130) which comprises the sections (105), (125), and (115). The latter section (115) is a dead end bore. Its depth in the embodiment shown is 75% of the material thickness of the lower cover plate (111). Instead of a dead end bore (115), a through-bore may also be used.

The lightweight construction panel (100) may also be curved, that is, it may be of cylindrical or spherical shape, as long as the material thickness of the support core is at least approximately constant.

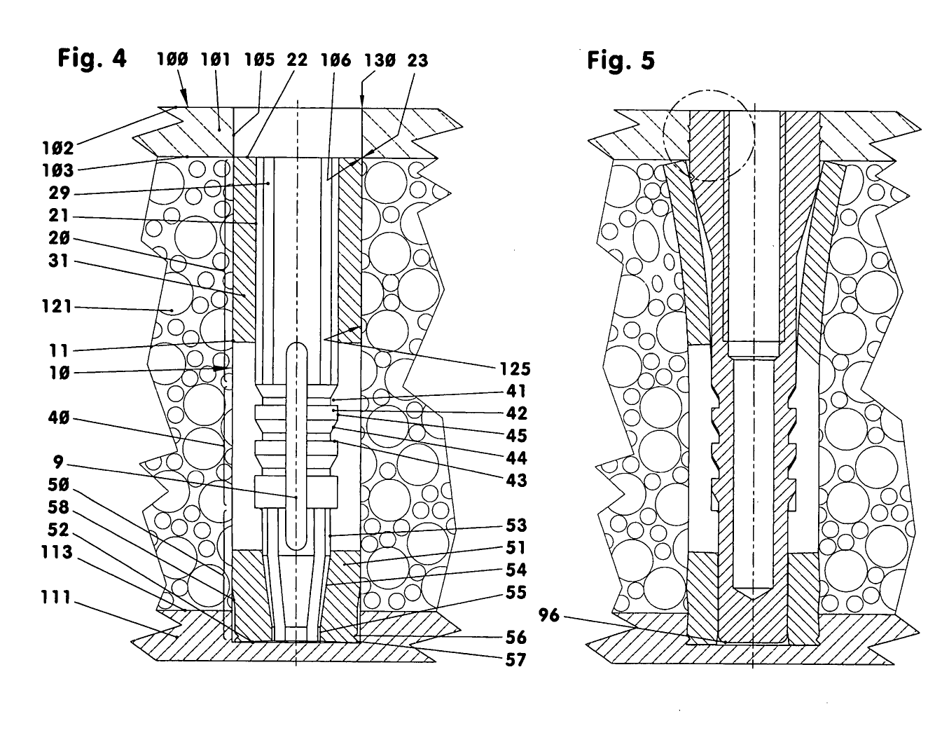

In accordance with FIG. 4, the expansion body (10) has essentially the shape of a tube, that is, it is a tubular body with an upper front face (22) and a lower front face (52). The expansion body (10) is divided into three areas; an engagement section (20), a locking zone (40) and a support section (50).

As shown in FIGS. 1 and 2, the upper area of the expansion section (10) which is for example cylindrical, has for example four straight longitudinal slots (29). The slots (29) however may also be spirally curved. They separate four locking elements (31) from one another. The length of the longitudinal slots (29) is for example 40 to 60% of the length of the expansion body. Their width is in the exemplary embodiment 0.5 mm and is constant over the full length of the anchor as long as it is not deformed. The longitudinal slots (29) have a 90° spacing. The longitudinal slots may also be spirally curved. They may end in radially arranged stress-relieving bores.

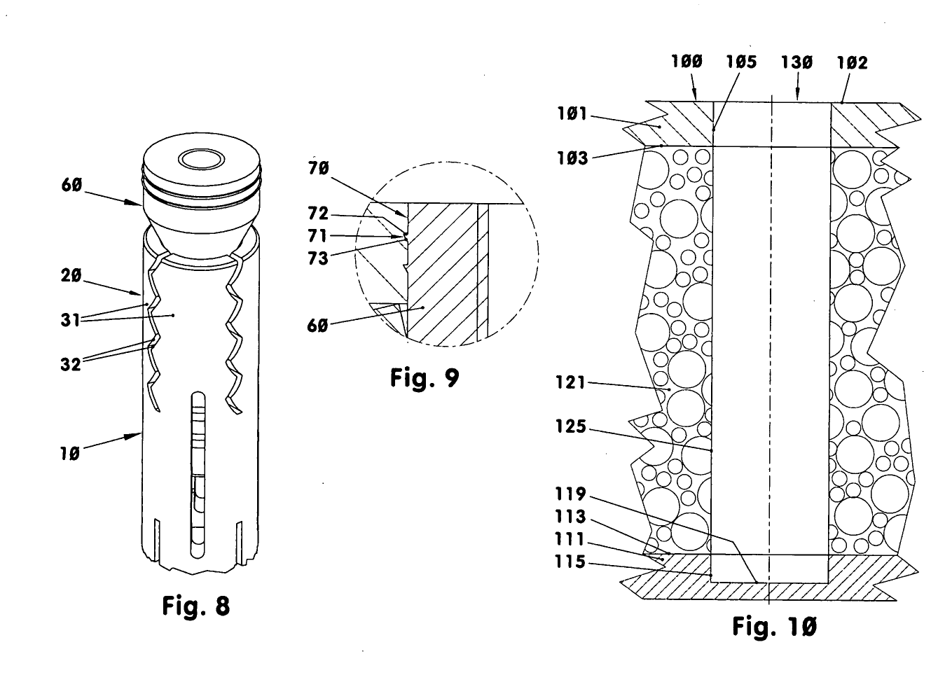

FIG. 8 shows an expansion body (10) which is provided for example with a zigzag, meander-shaped or merlon-like longitudinal slot (29). Upon unintended rotation of the installed anchor in the area of the support core (121)—by threading in of a screw, not shown, into the anchor—part of the locking flank sections (32) of the adjacent locking elements (31) come into contact with one another.

In the area of the locking elements (31), the inner wall (21) of the expansion body (10) has a cylindrical form.

At the upper end of the locking element (31) the expansion body (10) has a front face area (22) which in the present case is flat. Expediently, it may also have the shape of a flat truncated cone sleeve whose fictive tip is disposed on the center line (9) of the anchor above or below the upper expansion body end. In such a case, as cone angle, an angle of for example 156 angular degrees may be provided.

Since the expansion body (10) has a length which is equal to, or slightly smaller than, the shortest distance between the inner surfaces (103) of the cover plates (101, 111), the front face (22) is disposed, within the usual tolerances, in the plane of the inner surface (103) of the upper cover plate (101). According to FIG. 4, the outer edge (23) of the front face area (22) is disposed opposite the inner edge (106) of the bore (105). At its inner and outer edge the front face (22) is a chamfered or rounded, see FIG. 2.

Below the locking elements (31), there is a locking zone (40) which consists for example of three engagement projections (41) and three engagement recesses (42) which are arranged alternately one behind the other. The individual annular support projection (41) which has several interruptions has a saw tooth-like cross-sectional shape. The engagement projection distance is about one fourth of the expansion body diameter.

The individual support projection (41) is provided with a slide flank (44) and a support flank (43). The support flank (43) which, in accordance with the FIGS. 4 to 7, is disposed always below the slide flank (44) of the same support projection (41) is part of a plane which extends normal to the center line (9). The slide flank (44) has the form of a truncated cone sleeve. The cone angle of the sleeve is for example 60 angular degrees, wherein the imaginary tip, which is disposed on the centerline (9), is always below the support flank (43) of the respective support projection (41).

It is possible that also the slide flank (44) has the shape of a truncated cone sleeve whose imaginary tip is disposed in the area of the same support projections (41) or thereabove.

The bottom (45) of the engagement grooves (42) has a diameter which corresponds to the diameter of the cylindrical inner wall (21) of the engagement section (20).

In the area of the locking zone (40), there are in this case four relief slots (49) which extend parallel to the anchor center line (9). They are arranged in each case opposite the longitudinal slots (29) displaced by 45 angular degrees. The relief slots (49) which are rounded at their ends may extend upwardly and downwardly 0.1 to 3 mm beyond the locking zone. The width of the relief slots (49) is twice the width of the longitudinal slots (29). In the shown embodiment, this is one millimeter.

Adjacent the locking zone (40) toward the bottom, there is the at least partially cylindrical bottom section (50). Its outer contour which extends around for example a central cavity (53-55) ends with the lower end face (52). The upper part (53) of the cavity has a diameter which corresponds to the minimum diameter of the support projection (41). The intermediate part (54) of the cavity has for example the shape of a straight truncated cone whose tip angle is for example 16 degrees. The intermediate part becomes narrower toward the front face (52). Adjacent thereto there is for example a short cylindrical cavity section (55). The front face (52) in this case also has the shape of a truncated cone sleeve, whose tip angle is 172 angular degrees. The fictive cone tip is disposed on the center line (9) within the area of the cylindrical section (55).

When installed, the expansion body 10 is disposed with the support section (50) in the dead end bore (115) with little or no radial play. To this end, the outer contour of the support section (50) has a special shape. It is divided, with the expansion body undeformed as shown in FIG. 4, into a cone-shaped area (58) and a cylindrical area. The area (58) has a tip angle of 164 annular degrees. The diameter of the cylindrical area is about 0.4 millimeter less than the outer diameter of the outer contour (11). The length of the cylindrical area is greater than the depth of the bore (115).

At the lower rim of the cylindrical area of the outer contour, a circumferential groove (56) is provided so as to form a clamping web (57). The groove (56) has a triangular cross-section. The depth of the groove is 0.2 to 0.5 millimeter. The flanks of the groove (56) define therebetween an angle of for example 90 angular degrees. The lower flank of the groove (56) is spaced from the front surface (52) for example by 0.2 to 0.5 millimeters.

Alternatively to the structure formed by the groove (56) and the engagement web (57), the outer contour of the support zone (50) may be provided with a one or more-pitched thread, a circumferential transverse knurls or a nub structure.

Like the engagement section (30), the support zone (50) has for example four longitudinal slots, see FIGS. 1 and 2. The length of the slots (59) is for example 25 to 35% of the length of the expansion body. Its width in the shown embodiment is 0.5 millimeter and, in an undeformed anchor, is constant over the full length thereof. The longitudinal slots (59) have a 90° spacing and extend for example in alignment with the slots (29). For stress relief, the longitudinal slots (29) may be provided at their ends with radially arranged relief bores.

The front surface (52) of the expansion body (10) comes into contact at its outer edge with the bottom wall (119) of the dead end bore (115) essentially without any axial play.

The front surface (52) of the expansion body (10) may also be concavely curved or it may be structured so that it is in contact with the bottom wall (119) only by line contact, point contact or partial area contact. The roughness depth of a possibly used structure is below 0.5 millimeter.

FIG. 3 shows a wedge body (60), see also FIGS. 5 and 7. The shown wedge bodies (60) are rotationally symmetric components, at least over certain areas. They have in the shown example four sections: a seating section in the form of a cylinder zone (70), a spreading section forming a wedge zone (80), possibly an intermediate section (85), a locking zone (90) and a foot section (95).

The wedge body (60) has a central bore (61) for example with an internal metric thread (62). The thread (62) of the bore (61) ends in the exemplary embodiments shortly ahead of the locking zone (90).

Alternatively, the bore (61) may have a rectangular, oval, polygonal or star-like cross-section for accommodating non-metallic screws, such as particle plate screws or wood screws. Possibly, the bore cavity cross-section becomes smaller from the entrance end toward the inner end.

The seating section (70) of the wedge body (60) has an essentially cylindrical outer contour, see FIG. 3. This section (70) is disposed in connection with an anchor installed in a lightweight building panel (100) in the bore (105) of the upper cover plate (101) possibly with a press-fit. According to FIGS. 5 and 7 one fourth to one third of the length of the seating section (70) extends additionally into the area of the support core (121). The purely cylindrical part of the seating section (70), the cylinder zone, has here an outer diameter which corresponds to the inner diameter of the bore (105). In FIGS. 3 and 5, the seating section (70) has two circumferential retaining hook webs (71). The closed, annular retaining webs (71) have each a triangular cross-section, see FIGS. 5 and 7 with a support flank (72) and a slide flank (73). They project for example 0.15 mm over the respective cylindrical outer contour. They provide for a clamping of the wedge body (60) in the bore (105) which prevents rotation of the wedge body (60) in the bore (105). Additionally, the retaining hook webs seal the installation gap between the wedge body (60) and the light-weight construction panel (100), so that neither dirt nor moisture can enter. Also, in this way, no support core material can reach. the ambient.

Alternatively, the seating section (70) may include a plurality of longitudinal webs (74), see FIG. 7. In the present case, it has 15 longitudinal webs (74). All webs extend parallel to the centerline (9) of the anchor. Also, in this case, each web (74) has a triangular cross-section, wherein its flanks enclose for example an angle of 90° degree. Expediently, the cross-sections of the webs (74) increase from top to bottom. This increases the tightness of the mounting gap.

The seating section (70) is followed by the wedging zone. The latter comprises a truncated cone whose fictive tip is arranged in the zone below (85) or (90) on the centerline (9). The acute angle is between 30 and 45 angular degrees. In the embodiment shown, it is 33.4°. The minimum outer diameter of the wedging zone (80) corresponds to the inner diameter of the undeformed engagement section (20) of the expansion body (10).

In the embodiment shown, the wedging zone (80) is followed by a cylindrical intermediate section (85) and the locking zone (90). At least the end of the intermediate section (85) adjacent the locking zone (90) has the same outer diameter as the inner diameter of the undeformed engagement section (20). Independently of the representations of FIGS. 3 and 4, the wedging zone (80) and the intermediate section (85) can be combined to a rotationally symmetrical wedging section wherein the cross-sections of this new wedging section increases continuously from the locking zone (90) to the cylinder zone (70) and, at least in some areas, in a nonlinear manner, see FIG. 7. There, the locking elements (31) are engaged by the wedging body (60) at least over some part thereof.

The locking zone (90) of the wedge body (60) is in its design similar to the locking zone (40) of the expansion body (10). From top to bottom, there are three adjacent locking projections (91) of a locking groove (92), see FIG. 3. The spacing and the profile shape are known from the earlier described locking zone (40). Also, in this case, the locking projections (91) have each a planar support flank (93). However, the support flank is provided on top of each locking projection (94).

As shown in the figures, locking occurs exclusively in the separate locking zones (40, 90). But it is also possible to arrange the locking zones partially or completely for example in the wedging zone (80), or, respectively, the area of the engagement elements (31) and/or the clamping elements (51).

Adjacent the locking zone (90), there is a cylindrical bottom end section (95). It ends with a bottom wall (96), see FIG. 5. The outer diameter of the bottom end section (95) corresponds to the minimum groove bottom diameter of the engagement grooves (92). The foot section (95) may also be conical.

The expansion body (10) and the wedge body (60) consist for example of a polyamide.

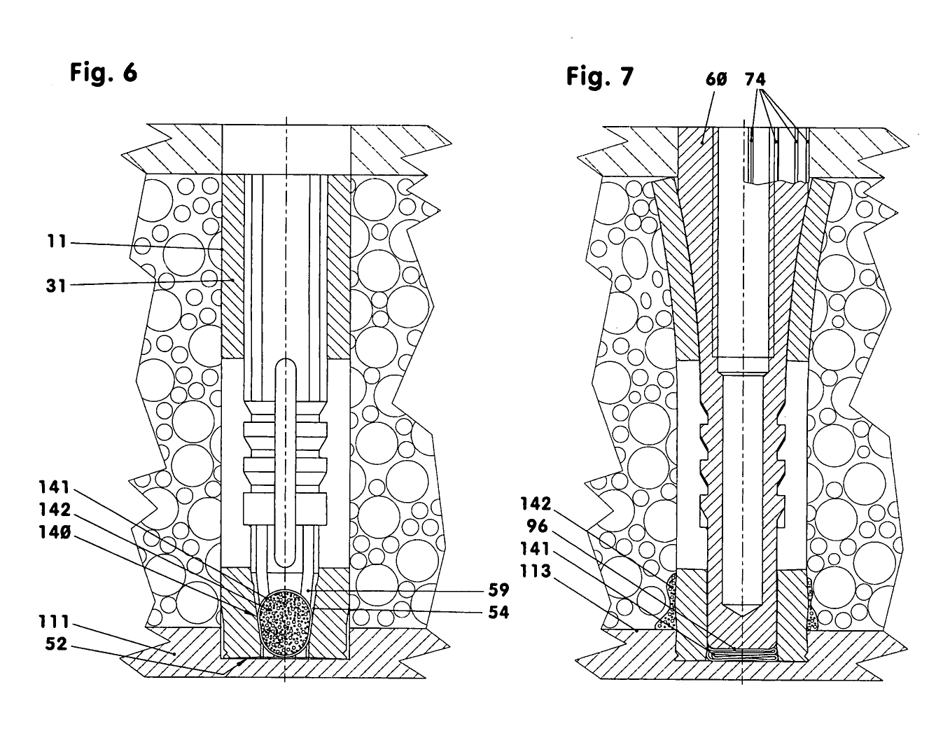

To facilitate mounting of the anchor, an opening is drilled through the first cover plate (101) and the support body (121). The opening is also drilled to a depth of 2.5 mm into the second cover plate (111) which in the shown embodiment has a thickness of four millimeter. The opening is not drilled through the cover plate (111). As drilling tool for example a spiral drill is used, which has a tip angle of 180 angular degrees. Also, a front face cutter tool may be used. Depending on the type of anchor, the opening (130) may also be drilled by a stepped face cutter for example if the dead end bore (115) in the lower cover plate (111) is to have a smaller diameter than the rest of the opening (105, 125), see FIGS. 6 and 7.

The dead end bore (115) may have an internal contour which is truncated cone-shaped rather than cylindrical. The support zone (50) then has a correspondingly adapted outer contour. Furthermore, instead of a circular cross-section, the dead end bore may have a rectangular, triangular or polygonal cross-section if a suitable manufacturing method is available. Furthermore, it is not necessary that the support zone fits snugly—in shape—into the dead end bore. The outer contour of the support zone (50) may for example have an outer shape of the support zone (50) with longitudinal grooves via which it is firmly and non-rotatably clamped in the cavity without any play.

The cavity or, respectively, bore (130) is blown out for example by compressed air or is sucked out.

The expansion body (10) is inserted into the empty bore (130) over the full length as shown in FIGS. 4 and 8 so that it abuts the bottom wall of the dead end bore 115 of the lower cover plate (111) and its front end face (22) is disposed on the level of the inner surface (103) of the upper cover plate (101). With the use of foamed support cores for example, the expansion body (10) is disposed in the bore (125) only with little play.

Upon installation of the wedge body (60) into the bore (21, 51) of the expansion body (10), the wedging zone (80) of the wedge body (60) presses the locking elements (31) of the expansion body (10) elastically apart, so that they extend behind the inner surface (103) of the first cover plate (101). The front face area (22) may be so designed, that it abuts with the whole face area thereof, the inner surface (103) of the cover plate (101).

As soon as the locking elements are being spread apart, the foot section (95) comes into contact with the cone-sleeve-shaped part (54) of the cavity of the support section (50). The spreading apart of the elastic clamping elements (51) disposed in the bore (115) now begins. This is terminated only when the front face (96) has almost reached the bottom (119), see FIG. 5, or, respectively, when the front end of the wedge body (60) has entered the cavity section (55). Then the clamping web (57) is fixedly engaged with the wall of the dead end bore (115). The clamping web (57) is impressed, at least in areas, into the material of the lower cover plate (111) in a form-locking manner, see FIGS. 5 and 7.

When the bottom section (95)—during introduction of the wedge body (60)—has reached about the center area of the cavity section (54), the cylinder zone (70) of the wedge body (60) is pressed into the bore section (105) of the upper cover plate (101).

Upon completion of the introduction of the wedge body (60), the cylinder zone (70) is disposed in the bore section (105) with a residual radial tension force and ends at least approximately flush with the outer surface (102) of the first cover plate (101). The upper, planar front face (63) of the wedge body (60) may be disposed one to three tenths of a millimeter below the outer surface (102) of the cover plate (101).

At the end of the spreading movement of the engagement elements (31) and the clamping elements (51), the locking projections (91) of the wedge body (60) are locked to the locking grooves (42) of the expansion body (10) in a non-releasable manner. During the three locking jumps occurring in the process, the expansion body (10) was each time expanded momentarily to a barrel-like shape. In the process, the relief slots (49) of the expansion body (10) were temporarily elastically expanded. After completion of the locking procedure, the expansion body (10) assumes in the locking zone (40) again a cylindrical contour (11). Now for example, a fixture to be mounted can be firmly attached by a screw threaded into the bore (61) of the wedge body (60).

In the manufacture of wooden furniture, the attachment strength of a fixture does not only depend on the pull-out resistance of the screws disposed in the anchors but also in the limiting of setting amounts and in the avoidance of looseness in the direction transverse to the center line of the respective screw. The anchor presented herein is retained in a direction transverse to the anchor center line (9) on one hand, via the cylinder zone (70) in the bore (105) of the first cover plate (101) and, on the other hand, its support zone (50) is also disposed in the second cover plate (111). This results in two effects that increase the anchor holding force. On one hand, the lower cover plate takes over part of the anchor retaining force by wedging the foot section (95) into the bore (115). On the other hand, the anchor is fixed transverse to the anchor center line (9) in a form and force locking manner. Since in addition, the anchor is, by design, not bendable, the screws disposed in the anchor do not tend to tilt which could result in an accelerated loosening of the connection. As a result, the chances of an unintended loosening or releasing of the fixture are minimized or even prevented.

In the shown embodiments, the wedge body is, as far as its outer contour is concerned at least to a large extent, a rotational symmetrical body. Alternatively, however, its various cross-sections or at least part thereof may have square, polygonal oval or otherwise profiled cross-sections. The wedge body (60) together with the expansion body (10) may be interconnected in the locking zone for example by a thread so that the wedge body is not installed in a linear, non-rotating movement, but by a screw-in movement. With the use of a thread in the mounting gap between the expansion body (10) and the wedge body (60), a locking or blocking structure is provided so that, after installation, the expansion body (60) can no longer be turned out or only with large effort.

In place of the form- and/or force-locking connection between the expansion body and the wedging body by means of locking zones or a thread, also a bayonet locking structure may be provided. The connection by means of a thread or a bayonet locking structure is considered to be equally effective as far as the locking zones are concerned.

The FIGS. 6 and 7 show an additional detail solution which provides for a supportive fixing of the anchor to the lower cover plate (111) by cementing. To this end, the expansion body (10) of the anchor is provided with a cement material cartridge or, respectively, balloon (140). In the cavity section (54) for example, a cement material balloon (140) is disposed. The cement material balloon (140) consists for example of a thin-walled membrane (141) which encloses a cement material (142) in a durable manner so that it will not dry up. Expediently, the membrane (141) includes two chambers so that it can store two different cement components separated from each other.

When now the wedge body (60) is pressed into the expansion body (10), see FIG. 7, the cement material balloon (140) is compressed between the bottom walls (96) and (52) such that it fractures. For assisting the desired fracturing effect, the cement balloon (140) may have a weak part designed to fracture when desired. It is also possible to arrange a puncturing or ripping device at one of the bottom walls (52, 96). A combination of weak area and fracturing device is also possible.

The cement material (142) discharged from the cement material balloon (140) is pressed by the advancement of the wedge body (60)—acting as a piston—through the bore (58) into the grooves (59). From there the cement material (142) is distributed between the bottom (52) and the inner surface (113) of the lower cover plate (111) and also in the area of the wall of the dead end bore (115). The excess cement (142) envelops additionally the lower area of the outer contour (11) of the expansion body (10).

By the cementing of the expansion body (10) or, respectively, the anchor to the lower cover plate (111) the latter assumes part of the load effective on the anchor.

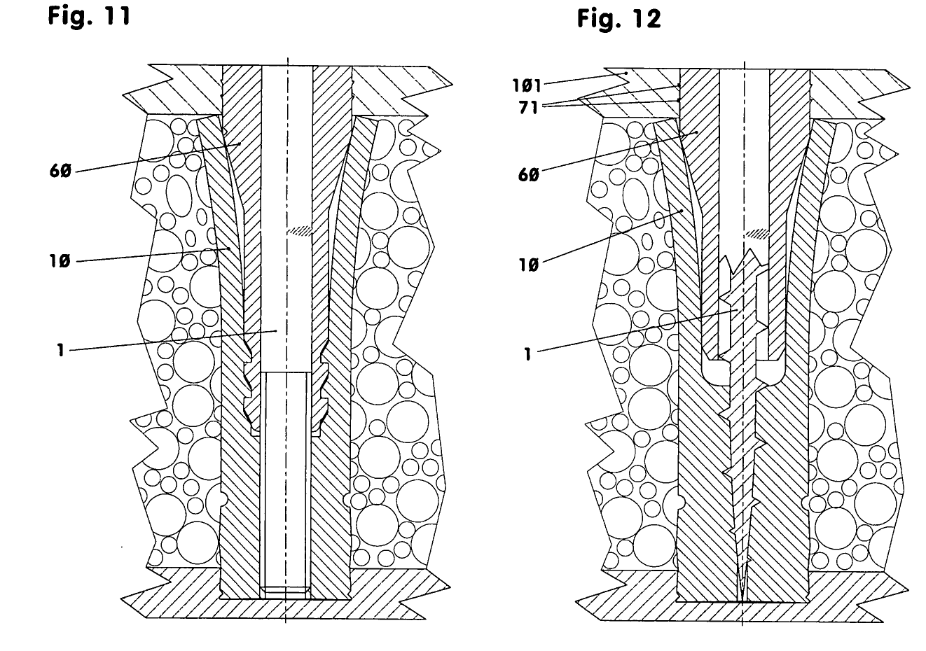

In the FIGS. 11 and 12, two different anchors are shown wherein the cementing material is not contained in the wedging body (60), but is screwed into the expansion body (10). In accordance with FIG. 14, the wedging body is non-releasably locked into the expansion body. A screw (1) with for example a metric thread is threaded into the expansion body (10).

In the anchor according to FIG. 12, no locking structure is provided. The wedge body (60) is retained in the cover plate (101) by barb webs (71), see also FIG. 9. As mounting means a a particle board screw (1) is used in this case.

In these FIGS. 11 and 12, the respecting mounting means (1) causes the spreading of the clamping zone (90) when being threaded into the anchor.

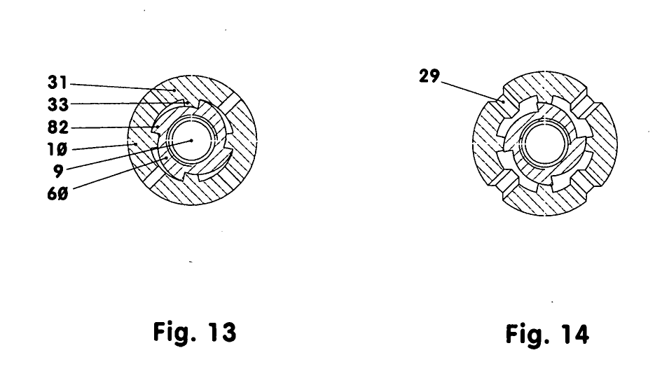

The FIGS. 13 and 14 are cross-sectional views of an anchor wherein the wedge body (60) is arranged in the expansion body (60) already before the installation of the anchor in the expansion body (10). The anchor is consequently preassembled installed in the bore (130)—see FIG. 4. The wedging zones of the wedge body (60) are in this case for example four eccentric elements (82) which, by rotation—about the longitudinal axis (9) of the anchor—expand the engagement elements (31) and expediently also the spreading elements (54) of the expansion body (10). In the process, the eccentric elements (82) slide along cams (33) which are formed onto the engagement elements (31).

The rotational movement of the wedge body (60) in the expansion body (10) may be limited or arrested for example by engagement elements or stops. In the FIGS. 15 and 16 the engagement elements and/or stops are disposed in another sectional plane which is not visible here.

Of course, the anchoring principle is not limited to anchors with at least partially cylindrical outer contour. The anchor may also be designed for example for a cavity which has an at least partially elongated or oval cross-section.

### LISTING OF REFERENCE NUMERALS

1 Mounting means, screw

9 Center line of the anchor

10 Expansion body

11 Outer wall, cylindrical contour

20 Engagement section

21 Inner wall, bore

22 Front face area

23 Outer edge

29 Longitudinal slots

30 Engagement section

31 Engagement elements, spreading elements

32 Engagement flank sections

33 Cam

40 Locking zone

41 Support projection

42 Engagement recesses, support grooves

43 Support flanks

44 Slide flanks

45 Groove bottom

49 Relief slots

50 Foot section, support zone

51 Dead end bores, chamber

52 Front area, bottom

53 Cylindrical cavity, chamber

54 Truncated cone sleeve-shaped cavity chamber

55 Cavity, cylindrical

56 Groove

57 Clamping web

58 Outer contour, truncated cone sleeve-shaped

59 Longitudinal grooves

60 Wedge body

61 Bore

62 Internal thread

63 Front face, top

70 Seating section, cylinder zone

71 Barbed webs, circumferential webs, surface structure

72 Support flank

73 Slide flank

74 Longitudinal webs, surface structure

80 Spreading section, wedging zone

82 Eccentric elements

85 Intermediate section

90 Locking zone

91 Engagement projection

92 Engagement recesses, engagement grooves

93 Support flank, planar

94 Slide flank

95 Bottom end section, clamping zone

96 Bottom, front face piston-like end

100 Sandwich panel lightweight composite panel, planar construction component with support core

101 Upper cover plate

102 Outer surface

103 Inner surface

105 Bore

106 Inner edge

111 Lower cover plate

113 Inner surface

115 Dead end bore, dead end cavity

119 Bottom of dead end bore (or cavity)

121 Support core, honeycomb core, foamed material core

125 Bore

130 Overall bore, cavity

140 Cement material cartridge, cement material balloon

141 Membrane

142 Cement material

1. Anchor for mounting on planar building panels (100) which are manufactured with a support core having a first cover plate (101) and a second cover plate (111) and at least one intermediate support core layer (121), the anchor including at least one expansion body (10) and at least one wedge body (60) and the wedge body (60) being at least partially inserted into the expansion body (10) and including an opening for the screwing in or pounding in a mounting means,
wherein
the building panel (100) is provided with a panel opening (130) which opening extends through the first cover plate (101) and the intermediate support core layer (121) and as dead end bore (115) partially into the second cover plate (111),
the expansion body (10) includes at least two spreadable locking elements (31, 54), at least one locking zone (40) and at least one support zone (50),
the wedge body (60) has at least one cylindrical zone (70), at least one wedging zone (80) and at least one locking zone (90), and
with the anchor installed in place, one cylinder zone (70) abuts in the bore (105) the first cover plate (101), a wedging zone (80) spreads apart the locking elements (31) of the expansion body (10) behind the first cover plate (101) and abutting the cover plate (101) so that the locking zones (40, 90) are locked together and the support zone (50) of the expansion body (10) abuts in the second cover plate (111) the dead end bore (115) walls axially and radially, the wedging body (60) having a clamping zone (95), which is expanded for firm engagement of the expansion body in the dead end bore (115).

2. Anchor according to claim 1, wherein the support zone (50) of the expansion body (10) extending into the dead end bore (115) of the cover plate (111) has a length which is 30 to 80% of the wall thickness of the cover plate.

3. Anchor according to claim 1, wherein the expansion body (10) has a tubular shape.

4. Anchor according to claim 1, wherein the expansion body (10) is provided, at least in some areas, with longitudinal slots for forming the locking elements (31).

5. Anchor according to claim 1, wherein in the area of the support zone (50) the wedge body (14) is at least partially slotted for forming the clamping elements (51).

6. Anchor according to claim 1, wherein the support zone (50) of the not installed expansion body (10) has a smaller outer diameter than the locking zone (40).

7. Anchor according to claim 1, wherein in the area of the support zone (50) the expansion body (10) has a central truncated cone-shaped cavity (54).

8. Anchor according to claim 1, wherein the wedging zone (80) of the wedge body (60) has a circular, a square, a polygonal or a star-shaped cross-section.

9. Anchor according to claim 1, wherein, with the anchor installed, the cylinder zone (70) of the wedge body (60) disposed in the bore (105) is provided with a structured surface (71, 74) to prevent rotation of the anchor.

10. Anchor according to claim 1, wherein the locking zones (40, 90) of the expansion body (10) and the wedge body (60) each are provided with a saw tooth profile.

11. Anchor for the attachment on flat construction panels (100) manufactured in a support core design, comprising first and second cover plates (101, 111) and at least one intermediate support core layer (121), wherein the anchor comprises an expansion body (10) and at least one wedge body (60) which is at least partially inserted into the expansion body (10) and includes an opening for screwing in or pounding in a mounting means,
wherein
the installed anchor is disposed in an opening (130) of the building panel (100) which extends through the first cover plate (101) and the intermediate support core layer (121) and partially into the second cover plate (111)
the expansion body (10) has at least two spreadable engagement elements (31) and at least one locking zone (40), at least one support zone (50) and a chamber (53, 54) including a cement material (142)—containing cartridge (140) and a discharge opening (59) at the bottom thereof,
the wedge body (60) includes at least one cylinder zone (70), at least one wedge zone (80) at least one locking zone (90) and a support zone (96), and
with the anchor installed, a cylinder zone (70) abuts the wall of the bore (105) in the first cover plate (101), a wedging zone (80) spreads the engagement elements (31) of the expansion body (10) behind the first cover plate (101) so that the locking zones (40, 50) are interlocked, the support zone (50) of the expansion body (10) is tightly radially clamped in the dead end bore (115) of the second cover plate (111) by its expansion by means of the clamping zone (95) of the wedge body (60) and the cement material (142) of the opened cement material cartridge (140) is distributed into the installation gaps between the lower cover plate (111) and the bottom end (52) of the expansion body (10).

12. Anchor for mounting in flat building panels (100) provided with a support core and having first and second cover plates (101, 111) and at least one intermediate support core layer (121) wherein the anchor includes at least one expansion body (10) and at least one wedge body (60) and wherein the wedge body (60) which is at least partially inserted into the expansion body (10) includes an opening for screwing or pounding in a mounting means,
wherein
the installed anchor is disposed in an opening (130) of the building panel (100) which opening extends through the first cover plate (101) and the intermediate support core layer (121) and into a dead end bore (115) formed into the second cover plate (111),
the expansion body (10) has at least two spreadable engagement elements (31) and at least a support zone (50),
the wedge body (60) includes at least a cylindrical zone (70), at least one wedge zone (80), and at least one clamping zone (95), and,
with the anchor installed, the cylinder zone (70) is engaged in the bore (105) of the first cover plate (101), a wedge zone (80) spreads apart the engagement element (31) of the expansion body (10) behind the first cover plate (101) so as to abut the first cover plate (101), and the support zone (50) of the expansion body (10) is radially engaged in the dead end bore (115) of the second cover plate (111) by an expansion of the expansion body (10) by means of the clamping. zone (95) of the wedge body (60).
